(19) United States
(12) Patent Application Publication
(10) Pub. No.: US 2014/0222675 A1
(43) Pub. Date: Aug. 7, 2014

(54) System and method for enabling anonymous money transfer

(71) Applicants: Shawn Mao, Silver Spring, MD (US); Wendy Mao, Silver Spring, MD (US)

(72) Inventors: Shawn Mao, Silver Spring, MD (US); Wendy Mao, Silver Spring, MD (US)

(21) Appl. No.: 13/759,391

(22) Filed: Feb. 5, 2013

(51) Int. Cl. G06Q 20/38; G06Q 20/10

(52) U.S. Cl. CPC G06Q 20/383; G06Q 20/10
USPC 705/44

(57) ABSTRACT

A method for enabling the transfer of currency between two parties that is comprised of an electronic application through which a receiver specifies the amount of money requested on a device, the device relays this information to a web server, which organizes this information and sends it to a central database which generates a unique transaction ID that is sent back to the web server and back to the device. The device translates this ID into a QR code, the payer scans the QR code, their device passes the ID through a web server and security filters for verification, routes the request to a central database, and executes the requested transfer without compromising the identities of either party. The application can be run on any compatible electronic platform and implements varying security verification techniques based on user preference.

### REFERENCES CITED

### U.S. Patent Documents

| | | |
|---|---|---|
| 5,726,435 | March 1995 | Hara et al. |
| 4,263,504 | April 1981 | Thomas |
| 5,966,702 | October 1997 | Fresko et al. |
| 7,263,550 | August 2007 | Peiffer |
| 5,315,642 | May 1994 | Fernandez |
| 5,850,517 | December 1998 | Verkler et al. |

### U.S. Patent Applications

| | | |
|---|---|---|
| 20120324242 | December 2012 | Kirsch |

### BACKORGUND OF THE INVENTION

Over half of all credit card fraud is due to identity theft, and the median fraud is about USD $399 per incident. This costs businesses and consumers millions in losses each year. There have been numerous endeavors to securing the process of sending and receiving money, but in most cases there is a direct link from the payer to the receiver. That is, the merchant receives a credit card number or some other piece of identifying information about the payer that can be intercepted by hackers or utilized by the merchant themselves. To circumvent this issue, a system in which neither party knew the identity of the other but could still securely transfer funds would prevent the unauthorized usage of information.

Any payment system that could be widely used by consumers must be convenient, which is why a mobile and computerized application for money transfer is the most logical choice. Over half of Americans own a smart phone, and even more own a personal computer. Many would hesitate to use their mobile device for financial transactions, however, due to the lack of security on their devices. If personal information is transmitted frequently on their device, the chances that personal information may be stolen increases dramatically. It would be useful to develop a system in which a mobile application was not allowed to access personal information, but only send requests for a central database to authorize payments.

### BRIEF SUMMARY OF INVENTION

The main objective of this invention is to provide an anonymous method of transferring funds from one party to another without releasing any identifying information about either party. This would allow consumers to shop online, shop at stores, and even handle personal transactions without having to worry about identity theft. The invention will include a mobile application which can be downloaded onto any mobile platform that enables users to register and send their personal information along with their bank account number upon registration. Since this information is never transmitted again, the risk of unauthorized usage by hackers decreases dramatically. The information is stored on a secure central database that cannot be accessed except by the database itself.

The application itself will allow a person requesting the money (henceforth referred to as the “receiver”) to specify the amount of money requested on their mobile application, which relays this information to a web server and then to the central database. The mobile application will present the receiver with a QR code, which can be scanned by the payer's mobile device using the same mobile application. Once the payer is authenticated, the funds are transferred to and from each individual bank account. Each party receives confirmation that the transaction was completed without having to know the identity of the other party. Thus, it is very difficult to initiate unauthorized transactions. If a party other than the payer scanned the QR code, that person would end up sending money to the receiver. In the event of unauthorized use of a mobile phone, the application itself will be secured by a variety of security measures specified by the original user. Money can be sent securely and anonymously, greatly simplifying daily transactions online and in person.

In other aspects, the invention provides a system and a method for implementing secure anonymous payments using mobile and computer devices. Upon review of additional documents such as the full description and drawings, other computer programs and methods within the scope of the invention will become obvious. It is intended that these items be included in this description of the invention and thus protected under the aforementioned claims.

### BRIEF DESCRIPTION OF THE DRAWINGS

Having provided a general description of the invention, presented herewith are descriptions of drawings that serve as reference for the invention.

FIG. 1 shows a flowchart depicting the transfer of information from individuals to the database during a monetary transaction in one embodiment of the present invention.

### DETAILED DESCRIPTION OF THE INVENTION

Reference will now be made to the previously described drawings, which exemplify some possible embodiments of the invention. Other embodiments may exist, and should not be constrained to those listed herein, which are only to serve as examples.

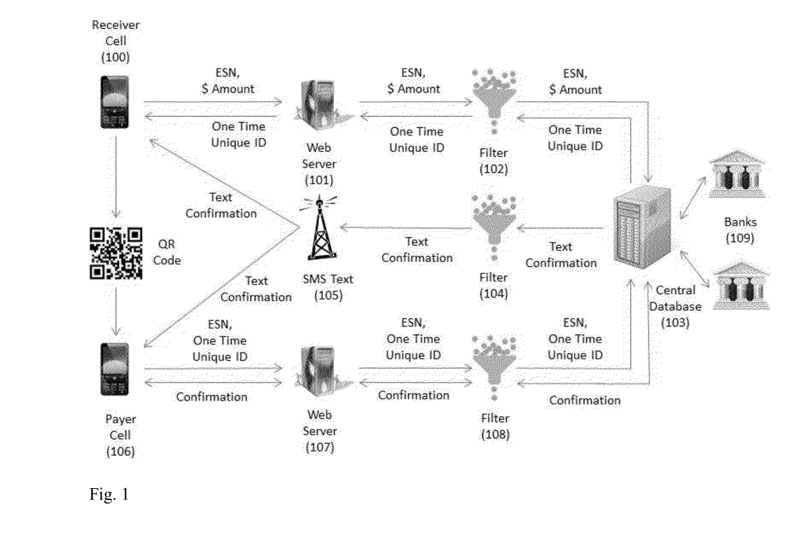

FIG. 1 shows the flow of information between devices during a transaction. A receiver initiates the transaction using the developed mobile application on a mobile device or a computer 100 which includes, but is not limited to, cellular phones and tablets.

The application will be developed and be available for download in web-based application stores. The language of development will vary according to mobile platform, but the resulting application will be identical across platforms. Upon opening the application for the first time, the user will be prompted to register in the system by inputting their first and last name, date of birth, address, zip code, phone number, e-mail address, and their bank account information which includes their bank account number, bank routing number, and additional information as required by law in various areas. The user will also be prompted to set up security measures for their mobile application, which includes inputting a personal identification number (PIN), a password, setting up a voice password, or setting up face recognition if available on the mobile platform of the device. One of these security measures must be selected before registration can occur. Partial of the personal information during the registration process can be entered through different devices, such as another computer or another mobile device to increase security. Once all the required information has been entered, the user will be prompted to verify and submit their information. The application will also record the phone's specific Electronic Serial Number (ESN) number or computer processor (CPU) ID number without user prompt. Upon submission, the mobile application will encrypt the user information via industry-standard 256-bit encryption and transmit the data through a secure data or wireless connection to a web server 101. The purpose of the web server is to consolidate and organize information from various mobile platforms into a format easily archived in the central database 103. It also serves to prevent any device from remotely accessing the central database by encrypting the information in the web server before it is transmitted to the central database. No record of the personal information is kept on the server other than the phone's ESN to indicate that the phone has already been registered on the server. There will be multiple web servers set up to lessen the time and distance information must travel to arrive at the nearest server, and the servers will all have access to a list of ESN's that have registered with the application. Once information has been reorganized and encrypted in the web server, it is then sent to security filters 102 that intercept malicious code and attempts at accessing the central database. The security filters pass the encrypted information to the central database 103 which stores the data as part of a sorted binary tree using individual ESN numbers as key.

Initiation of a transaction begins with the receiver, who opens their mobile application on their device 100 and will be prompted to input their previously indicated security verification. Once authenticated, they will be prompted to indicate whether they are receiving or transmitting money. Having indicated that they will be receiving money, the application will prompt the user for the amount requested. Once the user input is complete, the mobile device will encrypt the data and send it via a data connection or wireless connection to the web server 101 closest to their last known geographic location to facilitate transmission speed. The web server will authenticate the user by verifying that the ESN has indeed been registered on the server and the request came from the original phone. Following authentication, the server encrypts the ESN of the device along with the amount requested and sends it to the security filters 102 that will inspect for malware and malicious code. Afterwards, the encrypted information will be sent to the central database 103. The database will assign the account with the provided ESN a unique, one-time use transaction ID comprising of 12 or more numerical digits and assign the transaction ID with a flag indicating that the amount specified will be debited to the other phone with the identical transaction ID. The transaction ID is then sent back through the filters 102 for inspection and then to the web server 101 to transmit to the mobile device 100 in a format understood by the device. Once the mobile application receives the unique transaction ID, a quick response (QR) code associated with the unique transaction ID will be generated and displayed on the mobile screen.

Assuming the payer has also registered for the money transfer service, they can open their application on their device 106 and indicate that they are sending money. This will toggle the application to access the mobile device's camera, allowing the user to take a snapshot of the QR code. The application will utilize a color differentiation filter algorithm to identify the QR code in the image and an open source QR code reader such as ZBar to read the code and regenerate the transaction ID on the payer's phone 106. This transaction ID is sent to the closest web server 107 after authenticating the user. The web server passes the transaction ID and ESN of the payer device in encrypted form to the filters 108 that identify any malicious code in the request, and then passes the information to the central database 103. The central database will use the provided ESN number to identify the account node listed under the ESN, and use the transaction ID to determine the amount to debit the account. A request will be made to the payer's and receiver's banks 109 for the amount specified by the receiver using the bank routing numbers and account numbers specified when the users registered. Once the transfer is either completed or denied by the financial institutions 109, the flag assigned to that transaction ID will now be set to completed or denied, marking the transaction number for invalidation. In the event that multiple requests were sent, the flag on the transaction ID will indicate that more than the allotted number of requests have been made and will deny the request. Should the request for transfer be denied by either or both financial institutions involved in the money transfer, the transaction ID will still be invalidated. Once the flag on the transaction is set to completed or denied, the central database 103 will encrypt the flag indicating success or failure and send it through a filter 104 along with the phone numbers, but not the ESN's, of the two devices involved in the transaction to a text program 105 hosted on a web server. The program will then send a SMS text to each user to indicate the success or failure of their transaction using a pre-composed message template not exceeding 160 characters indicating the status of the transfer and how much was transferred. In the event that a user indicated they would not like to receive SMS on their device, the central database 103 will include an email address rather than the phone number of the user to notify.

In the case of a web-based embodiment of the aforementioned anonymous payment system, the mobile device 100 in FIG. 1 can be replaced with a merchant's web server. The merchant can download the computer version of the application with the same functionality as the mobile versions, and generate a QR code to be displayed on the checkout page when a customer checks out. The customer can scan the QR code using their mobile device and have the funds transferred to the merchant's account without revealing their credit card number or any other identifying information.

Although the aforementioned embodiments show the ability of the invention to transfer funds between users that have application enabled devices with cameras or a data connection, the user interface of the invention can be modified to adjust for different device capabilities. Instead of generating a QR code, a receiver can choose to directly obtain the numeric transaction ID to give to a payer. The transaction ID can be manually inputted into the mobile application in the case where a phone does not have a camera, or texted to a randomly generated number that the web server generates for the payer.

Implementations have been put in place to safeguard personal information from unauthorized access and/or use. Each party only has to input personal identifiable information once, when they are registering. The elimination of the need to input information that directly links to a bank account limits the chances of unauthorized access to account information. Encryption occurs at every point of data transmission, which ensures that the information cannot be modified or used except at designated and secured destinations such as the web server 101 or the central database 103. Users can also choose to specify the security level of their account. For example, every time the application is opened, users are prompted to enter a pre-specified password or some other unlocking mechanism. Users also are notified on their device each time a transaction happens via the anonymous money transfer system, and can elect to have the application require a password before every final transaction is approved. The transaction ID codes are unique and only valid for one-time use, so unauthorized obtainment of the transaction ID for future use would prove useless. Both the receiver and the payer only are exposed to the transaction ID and the amount of transaction at any given point in time. The central database 103 holds all the information on the users and is protected by filters that detect malware at every point where it sends or receives user information.

While the invention has been described as thoroughly in various exemplary embodiments, it should be understood that many changes and substitutions can be made to elements of these embodiments that still fall within the scope of the aforementioned claims. Therefore, the embodiments and specific terms listed should be regarded as descriptive and not as limitations.

what is claimed is:

1. A method for providing a means of anonymous money transfer comprising: per transaction, communication between a device and web server entailing the amount of money requested; communication between the web server and the central database involving the generation of an one-time unique transaction ID, the secure transfer'of the information to the web server and back to the device; the generation of a QR code by the one to receive funds, the recognition of the QR code by the device of the payer, the secure transfer of information from the web server to a central database which handles fund transfer requests through individual banks, and the secure transfer of information regarding the success of the transfer request through the central database back to the individual web servers and back to the electronic device that generated the code.

2. The method of claim 1, further comprising a secure method of communicating between the web server and the central database, involving the implementation of security filters and encryption that can only be decrypted within the databases themselves.

3. The method of claim 2, wherein the central database generates and stores a unique transaction ID such that when it receives a corresponding ID from another device, the funds are deducted from that account and placed into the receiving account.

4. The method of claim 3, wherein the transaction ID is securely conveyed to the web server which then transmits it to the device requesting funds (the receiver).

5. A central database that securely encrypts and stores the personal information of all users and can request direct fund transfers between bank accounts using this information.

6. The method of claim 1, further comprising a secure method of sending a request from a device to a dedicated web server, authenticating the device and conveying the amount of money requested that can be recognized by the web server.

7. The method of claim 1, further comprising an algorithm of generating a unique QR code on the device of the receiver based on the transaction ID received from the web server.

8. A web server that recognizes the platforms on which the communicating device is operating, and can translate and organize the information sent by the device into a form recognized by the central database.

9. The method of claim 8, further comprising of a method for communication with and recognition of information generated by other web servers.

10. The method of claim 1, further comprising of an algorithm that generates a unique transaction ID on the payer's device following the scanning and recognition of the QR Code by the payer's device using image capture technology.

11. The method of claim 10, wherein the QR code scanned by the payer can be translated into a unique transaction ID that is sent securely to the web server on which their information is stored.

12. The method of claim 1, further comprising of a method for the payer's web server to recognize the transaction ID as a request for money from the payer's account.

13. The method of claim 1, further comprising of a method for implementing security filters that allow the web server(s) to communicate their requests to the central database.

14. The method of claim 1, wherein the central database transfers the funds from the payer's to the receiver's bank account and securely sends a text confirmation to both parties about the status of the transfer.

15. The method of claim 1, wherein the central database invalidates the transaction ID so it cannot be used again.

16. The mobile and computer application of claim 1, which can be run on a myriad of different devices, allowing for the generation of payment requests, the scanning of QR codes, the translation of a scanned QR code into a transaction ID, and the secure communication of that information to the web servers.

17. The mobile and computer application of claim 16, further comprising of security settings that can be toggled on or off by the user, involving different degrees of security from inputting a PIN, inputting a password, voice recognition, and face recognition.

18. The mobile and computer application of claim 16, wherein users must input their personal information upon registering, and the information is securely sent and stored to the central database.
